(19) United States
(12) Patent Application Publication
(10) Pub. No.: US 2025/0303289 A1
(43) Pub. Date: Oct. 2, 2025

(54) Virtual Character Display Method and Apparatus, Terminal, Storage Medium, and Program Product

(71) Applicant: Tencent Technology (Shenzhen) Company Limited, Shenzhen (CN)

(72) Inventors: Yingting Zhu, Shenzhen (CN); Liang Kang, Shenzhen (CN); Danxing Xu, Shenzhen (CN)

(21) Appl. No.: 19/231,937

(22) Filed: Jun. 9, 2025

Related U.S. Application Data
(63) Continuation of application No. PCT/CN2024/087929, filed on Apr. 16, 2024.

(30) Foreign Application Priority Data
Jun. 21, 2023 (CN) 2023107519259

(51) Int. Cl. A63F 13/52; A63F 13/537; A63F 13/56

(52) U.S. Cl. CPC A63F 13/52; A63F 13/537; A63F 13/56

(57) ABSTRACT

This application relates to the field of human-machine interaction, and describes virtual character display techniques. The techniques may include displaying a formation selection interface, the formation selection interface having at least one formation template, the formation template having at least two character formation positions, where each of the character formation positions is configured for assigning a virtual character, and each of the character formation positions has a corresponding formation position character state. When a target template is selected, character formation positions included in the target template may be displayed in a virtual environment. A virtual character may be depicted in the template in a target formation position character state corresponding to the target character formation position. Aspects described enable a virtual character to be presented in the character state corresponding to the target character formation position set in the formation template in the virtual environment.

### CROSS-REFERENCE TO RELATED APPLICATIONS

This application is a Continuation application of PCT Application PCT/CN2024/087929, filed Apr. 16, 2024, which claims priority to Chinese Patent Application No. 2023107519259, filed Jun. 21, 2023, each entitled “VIRTUAL CHARACTER DISPLAY METHOD AND APPARATUS, TERMINAL, STORAGE MEDIUM, AND PROGRAM PRODUCT” and each of which is incorporated herein by reference in its entirety.

### FIELD

Aspects described herein relate to the field of human-computer interaction technologies, and in particular, to a virtual character control technology.

### BACKGROUND

As an electronic game, online role-playing games allow players to perform role playing as one or more virtual characters online and control activities and behaviors of the virtual characters. In a gaming scenario, a player may change an action, an appearance, and the like of a virtual character.

In the related art, a player may edit a form of a single virtual character through an action editor, and change an attire, an action, and the like of the virtual character, so that the virtual character can be presented in a state desired by the player. Moreover, after the player exits the action editor, the virtual character can remain in the state edited by the player.

However, in the solution provided in the related art, a player may select only one virtual character in an account thereof, shape a single virtual character in the action editor, and save the shaped virtual character as a fixed image of the virtual character. Virtual character shaping efficiency is low, and a virtual character display manner is excessively single.

### SUMMARY

Aspects described herein provide a virtual character display method and apparatus, a terminal, a storage medium, and a program product, to help improve efficiency of shaping virtual characters and enrich manners of shaping and displaying a character.

Technical solutions are as follows:

An aspect described herein provides a virtual character display method, which is performed by a terminal and includes:
displaying a formation selection interface, the formation selection interface including at least one formation template, the formation template including at least two character formation positions, each of the character formation positions being configured for carrying a virtual character, and each of the character formation positions having a corresponding formation position character state;
displaying, in response to an application operation performed on a target formation template in the formation selection interface, character formation positions included in the target formation template in a virtual environment; and
controlling, in a case that the virtual character is located in a target character formation position in the target formation template, the virtual character to present a target formation position character state corresponding to the target character formation position.

Another aspect described herein provides a virtual character display apparatus, including:
a display module, configured to display a formation selection interface, the formation selection interface including at least one formation template, the formation template including at least two character formation positions, each of the character formation positions being configured for carrying a virtual character, and each of the character formation positions having a corresponding formation position character state,
the display module being further configured to display, in response to an application operation performed on a target formation template in the formation selection interface, character formation positions included in the target formation template in a virtual environment; and
a control module, configured to control, in a case that the virtual character is located in a target character formation position in the target formation template, the virtual character to present a target formation position character state corresponding to the target character formation position.

Another aspect described herein provides a terminal, including a processor and a memory, the memory having at least one instruction, at least one program, a code set, or an instruction set stored therein, the at least one instruction, the at least one program, the code set, or the instruction set being loaded and executed by the processor to implement the virtual character display method in the foregoing aspect.

According to another aspect, a computer-readable storage medium is provided, having at least one instruction, at least one program, a code set, or an instruction set stored therein, the at least one instruction, the at least one program, the code set, or the instruction set being loaded and executed by a processor to implement the virtual character display method in the foregoing aspect.

Another aspect described herein provides a computer program product or a computer program, the computer program product or the computer program including computer instructions, the computer instructions being stored in a computer-readable storage medium. A processor of a terminal reads the computer instructions from the computer-readable storage medium, and the processor executes the computer instructions, to cause the terminal to perform the virtual character display method in the foregoing aspect.

The technical solutions provided in the aspects described herein bring at least the following beneficial effects:

In the aspects described herein, the terminal may display, in a virtual environment, a formation template selected by a user, the formation template including at least two character formation positions, and display, when the virtual character is located in a target character formation position in the formation template, the virtual character in a target formation position character state corresponding to the target character formation position. Therefore, a formation position character state corresponding to a character formation position in the formation template may be set, so that the virtual character located in the character formation position in the formation template can present the formation position character state corresponding to the character formation position in the virtual environment when the formation template is used. In other words, the virtual character is controlled to be in a particular character formation position in the formation template, to quickly display the virtual character in the corresponding character state, so that efficiency of controlling the virtual character is improved. In addition, the character state of the virtual character does not need to be manually controlled to be adjusted, which simplifies related user operations. In addition, because the formation template usually includes at least two character formation positions, at least two virtual characters may be simultaneously controlled to present corresponding character states rather than controlling a single virtual character to present a particular character state. In addition, since the character state presented by the virtual character is consistent with the formation position character state in the formation template, the at least two virtual characters can present interactive states based on the formation template during display of the virtual character, thus enriching virtual character display forms and diversifying virtual character display manners.

### BRIEF DESCRIPTION OF THE DRAWINGS

FIG. 1 is a schematic diagram of an implementation environment according to an illustrative aspect described herein.

FIG. 2 is a flowchart of a virtual character display method according to an illustrative aspect described herein.

FIG. 3 is a schematic diagram showing a virtual character display process according to an illustrative aspect described herein.

FIG. 4 is a flowchart of a process of displaying a character formation position in a virtual environment according to an illustrative aspect described herein.

FIG. 5 is a schematic diagram of an application process of a target formation template according to an illustrative aspect described herein.

FIG. 6 is a schematic diagram of displaying a formation position editing interface according to an illustrative aspect described herein.

FIG. 7 is a schematic diagram of some controls in the formation position editing interface according to an illustrative aspect described herein.

FIG. 8 is a schematic diagram of displaying a formation position editing interface according to another illustrative aspect described herein.

FIG. 9 is a schematic diagram of adjusting a location of a character formation position according to an illustrative aspect described herein.

FIG. 10 is a schematic diagram of adjusting an orientation of a character formation position according to an illustrative aspect described herein.

FIG. 11 is a flowchart of a manner of switching a body shape of a virtual character according to an illustrative aspect described herein.

FIG. 12 is a schematic diagram of a candidate character list according to an illustrative aspect described herein.

FIG. 13 is a schematic diagram of controlling a virtual character to be in a target character formation position according to an illustrative aspect described herein.

FIG. 14 is a schematic diagram of a process of withdrawing a formation template according to an illustrative aspect described herein.

FIG. 15 is a structural block diagram of a virtual character display apparatus according to an illustrative aspect described herein.

FIG. 16 is a structural block diagram of a terminal according to an illustrative aspect described herein.

### DETAILED DESCRIPTION

To make objectives, technical solutions, and advantages described herein clearer, implementations described herein are described in further details below with reference to drawings.

Terms involved in aspects described herein are first briefly described.

Virtual environment: It is a virtual environment displayed (or provided) during running of an application on a terminal. The virtual environment may be a simulated environment of the real world, a semi-simulated and semi-fictitious environment, or a purely fictitious environment. The virtual environment may be any one of a two-dimensional virtual environment, a 2.5-dimensional virtual environment, and a three-dimensional virtual environment, which is not limited in this application. The following aspect is described by using an example that the virtual environment is a three-dimensional virtual environment.

Virtual character: It refers to a movable object in a virtual environment. The movable object may be at least one of a virtual character, a virtual animal, and a cartoon character. In some aspects, when the virtual environment is a three-dimensional virtual environment, the virtual character may be a three-dimensional virtual model. Each virtual character has a shape and a volume in the three-dimensional virtual environment, and occupies a partial space in the three-dimensional virtual environment. In some aspects, the virtual character may be a three-dimensional character constructed based on a three-dimensional human skeletal technology. The virtual character realizes different external appearances by wearing different skins. In some implementations, the virtual character may alternatively be implemented through a 2.5-dimensional or 2-dimensional model, which is not limited in the aspects described herein.

Formation: It refers to an arrangement of locations between a plurality of different virtual characters in a virtual environment. At least two formation positions exist in a formation.

Formation position: It refers to locations of the different virtual characters in a formation, and the formation positions in the formation may be configured for carrying virtual characters.

In some aspects, quantities of formation positions and locations of the formation positions included in different formations are different. Moreover, one formation position generally can carry only one virtual character. Certainly, based on demands in different virtual environments, quantities of virtual characters that can be carried at different formation positions may be different, which is not limited in the aspects.

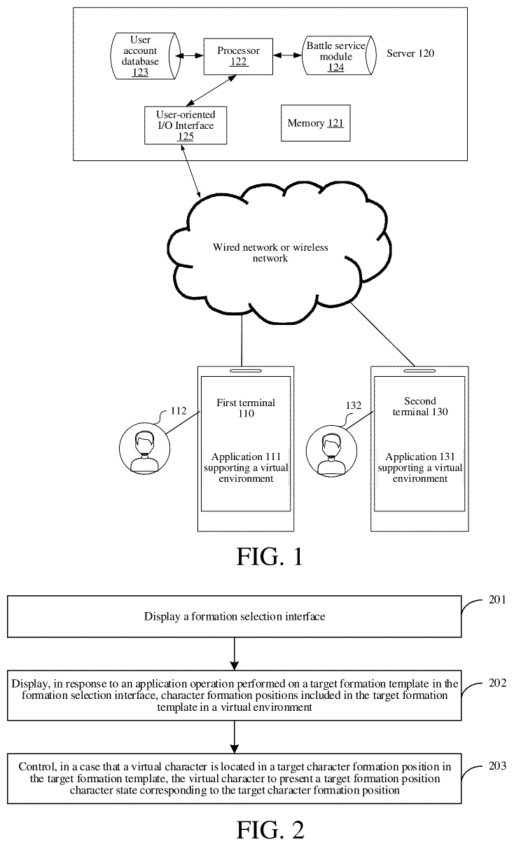

FIG. 1 is a schematic diagram of an implementation environment according to an illustrative aspect described herein. The implementation environment includes a first terminal 110, a server 120, and a second terminal 130.

An application 111 supporting a virtual environment is run in the first terminal 110. When the application 111 is run in the first terminal, a user interface of the application 111 is displayed on a screen of the first terminal 110. The application 111 may be a multiplayer online battle arena (MOBA) game, a simulation game (SLG), or the like. In this aspect, an example in which the application 111 is a multiplayer online role-playing game (MMORPG) is used for description. The first terminal 110 is a terminal used by a first user 112. The first user 112 controls a first virtual character in the virtual environment to perform activities by using the first terminal 110. The first virtual character may be referred to as a primarily controlled virtual character of the first user 112. The activities of the first virtual character include, but are not limited to at least one of adjusting a body posture, crawling, walking, running, riding, flying, jumping, driving, picking, shooting, attacking, throwing, and releasing a skill. Exemplarily, the first virtual character is a first virtual person, for example, a simulated person or a cartoon person.

An application 131 supporting a virtual environment is run in the second terminal 130. When the application 131 is run in the second terminal 130, a user interface of the application 131 is displayed on a screen of the second terminal 130. The application 131 may be a MOBA game, an SLG, or the like. In this aspect, an example in which the application 131 is a MMORPG game is used for description. The second terminal 130 is a terminal used by a second user 132. The second user 132 controls a second virtual character in the virtual environment to perform activities by using the second terminal 130. The second virtual character may be referred to as a primarily controlled virtual character of the second user 132. Exemplarily, the second virtual character is a second virtual person, for example, a simulated person or a cartoon person.

In some aspects, the first virtual character and the second virtual character are in the same virtual environment. In some aspects, the first virtual character and the second virtual character may belong to the same camp, the same team, the same organization, have a friend relationship, or have a temporary communication permission. In some aspects, the first virtual character and the second virtual character may belong to different camps, different teams, or different organizations, or may be rivals.

In some aspects, the application 111 installed in the first terminal 110 is same as the application 131 installed in the second terminal 130, or the applications installed in the two terminals are applications of the same type on different operating system platforms (such as Android or IOS). The first terminal 110 may generally refer to one of a plurality of terminals, and the second terminal 130 may generally refer to another of the plurality of terminals. In this aspect, only the first terminal 110 and the second terminal 130 are used as an example for description. The first terminal 110 and the second terminal 130 are of the same device type or different device types. The device type includes at least one of a smart phone, a tablet computer, an e-book reader, a moving picture experts group audio layer III (MP3) player, a moving picture experts group layer IV (MP4) player, a laptop computer, and a desktop computer.

The first terminal 110, the second terminal 130, and the other terminals communicate with the server 120 through a wired or wireless network.

The server 120 includes at least one of one server, a server cluster including a plurality of servers, a cloud computing platform, and a virtualization center. The server 120 is configured to provide a background service for the application supporting the virtual environment. In some aspects, the server 120 is in charge of primary computing, and the terminals are in charge of secondary computing; or the server 120 is in charge of secondary computing, and the terminals are in charge of primary computing; or the server 120 and the terminals perform collaborative computing by using a distributed computing architecture.

In an example, the server 120 includes a memory 121, a processor 122, a user account database 123, a battle service module 124, and a user-oriented input/output interface (I/O interface) 125. The processor 122 is configured to load instructions stored in the server 120, and process data in the user account database 123 and the battle service module 124. The user account database 123 is configured to store data of user accounts logged in the first terminal 110, the second terminal 130, and another terminal, such as avatars of the user accounts, nicknames of the user accounts, combat effectiveness indices of the user accounts, and service areas in which the user accounts are located. The battle service module 124 is configured to provide a plurality of battle rooms for users to perform battles, for example, a 1V1 battle, a 3V3 battle, or a 5V5 battle. The user-oriented I/O interface 125 is configured to establish communication with the first terminal 110 and/or the second terminal 130 through the wireless or wired network to exchange data.

FIG. 2 is a flowchart of a virtual character display method according to an illustrative aspect described herein. This aspect is described by using an example in which the method is performed by the first terminal 110, the second terminal 130, or another terminal in the implementation environment shown in FIG. 1. The method includes the following operations:

Operation 201: Display a formation selection interface.

The formation selection interface includes at least one formation template, the formation template includes at least two character formation positions, each of the character formation positions is configured for carrying a virtual character, and each of the character formation positions has a corresponding formation position character state.

The formation position character state refers to a character state presented when the virtual character is located in the character formation position. In addition, when different virtual characters are located in the same character formation position, character states presented by the different virtual characters are the same. The formation position character state includes an orientation, a posture, and an action of the virtual character. In addition, in a process of editing the formation template, the formation position character state of each character formation position in the formation template may be edited, so that each character formation position has a corresponding formation position character state.

The virtual character refers to a character controlled by a user in the virtual environment. The user may control the virtual character to be located in a formation position in the formation in the virtual environment. The virtual environment may be an environment in which the virtual object is located in a virtual world during running of the application in the terminal, which may be a two-dimensional environment, a three-dimensional environment, or the like. In this aspect described herein, the virtual environment is observed by using a camera model.

In some aspects, the camera model automatically follows a virtual character in the virtual world. To be specific, when a location of the virtual object in the virtual world is changed, an observation perspective of the camera model is changed with the location of the virtual object in the virtual world, and the camera model is always within a preset distance range of the virtual object in the virtual world. In some aspects, in the automatic following process, relative locations of the camera model and the virtual object are unchanged.

The camera model is a three-dimensional model in the virtual world located around the virtual object. When a first-person perspective is used, the camera model may be located near a head of the virtual object or located at the head of the virtual object. When a third-person perspective is used, the camera model may be located behind the virtual object and bound to the virtual object, or may be located at any location at a preset distance from the virtual object. The virtual object located in the virtual world may be observed at different angles by using the camera model. In some aspects, when the third-person perspective is a first-person over-the-shoulder perspective, the camera model is located behind the virtual object (for example, behind the head and a shoulder of the virtual object). In some aspects, in addition to the first-person perspective and the third-person perspective, the perspective further includes another perspective, such as a top-down perspective. When the top-down perspective is used, the camera model may be located above the head of the virtual object, and the top-down perspective is a perspective for observing the virtual world from the air. In some aspects, the camera model is not actually displayed in the virtual world. In other words, the camera model is not displayed in the virtual world displayed on the user interface.

In some aspects, the user may perform a trigger operation on the formation selection interface, to display the formation selection interface over a view of the virtual environment. In some aspects, the formation selection interface includes a plurality of formation templates, which may include a default formation template in a system, or may include a formation template designed by a player controlling a virtual character.

Operation 202: Display, in response to an application operation performed on a target formation template in the formation selection interface, character formation positions included in the target formation template in a virtual environment.

In some aspects, the application operation may be a tapping/clicking operation, a dragging operation, a sliding operation, or the like triggered by the user on a control corresponding to the target formation template in the formation selection interface. A specific operation manner of the application operation is not limited in this application.

In some aspects, after the application operation is triggered on the target formation template in the formation selection interface, the formation may be previewed in the virtual environment, to display an application effect of the target formation template in the virtual environment to the user. In addition, after the preview formation is displayed, in response to a moving operation, a rotating operation, and the like performed on the character formation position included in the target formation template, an application location of the character formation position in the virtual environment and an application angle of the formation in the virtual environment may be changed. In addition, the application effect of the moved or rotated target formation template is displayed in real time in the virtual environment based on the moving operation or the rotating operation. After responses are made to the moving operation or the rotating operation performed on the character formation position of the target formation template, relative locations and relative orientations between different character formation positions in the formation do not change.

In some aspects, the terminal displays a preset formation and an application confirmation control in response to the application operation performed on the target formation template. The character formation positions included in the target formation template are displayed in the virtual environment in response to a trigger operation performed on the application confirmation control.

Operation 203: Control, in a case that the virtual character is located in a target character formation position in the target formation template, the virtual character to present a target formation position character state corresponding to the target character formation position.

In this aspect described herein, a plurality of users may control a plurality of virtual characters to be located in different target character formation positions, or a single user may control a plurality of virtual characters to be located in different target character formation positions, which is not limited in this aspect.

In response to a virtual character selection operation performed on the target character formation position, the terminal determines a virtual character selected by the user to be located in the target character formation position, and displays the virtual character in the target formation position character state corresponding to the target character formation position.

In this aspect described herein, the at least two character formation positions included in the formation template may correspond to the same or different formation position character states, and the formation position character states corresponding to the different character formation positions are determined when the formation template is generated.

In a possible implementation, in a case that the plurality of virtual characters are all located in the target character formation position, and the virtual characters in the target character formation position present the target formation position character state corresponding to the target character formation position, a virtual camera model is controlled to take photographs of the plurality of virtual characters. Obtained images include the plurality of virtual characters present the target formation position character state corresponding to the target character formation position.

In the related art, during photographing of a plurality of virtual characters, a user usually needs to manually control actions, positions, orientations, postures, and the like of the virtual characters. However, in the multi-virtual character photographing manner provided in the foregoing implementation, after a virtual character enters a character formation position, a formation position character state corresponding to the character formation position may be automatically presented, which simplifies a process of manually adjusting a virtual character when a user takes photographs of a plurality of virtual characters, thereby effectively improving efficiency of multi-virtual character photographing.

In some aspects, when the virtual camera model is controlled to take photographs of the virtual character, the target character formation position in the virtual environment is controlled to be in a hidden state, so that an image obtained through photographing does not include the target character formation position, and includes only the virtual environment and the virtual character in a corresponding formation position character state, thereby achieving a better photographing effect.

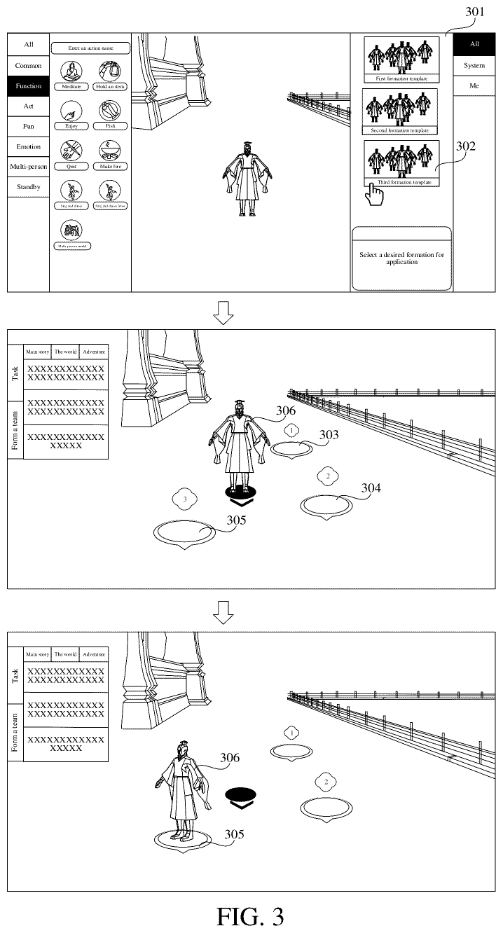

Exemplarily, FIG. 3 is a schematic diagram of a virtual character display process according to an illustrative aspect described herein. In a formation selection interface 301, a first formation template, a second formation template, and a third formation template are displayed. It is assumed that the third formation template includes three character formation positions. The terminal displays, in response to an application operation (corresponding to a tapping/clicking operation in the figure) performed by a user on a target formation template 302 (the third formation template) on the formation selection interface 301, a first character formation position 303, a second character formation position 304, and a third character formation position 305 included in the target formation template in a virtual environment. When the user selects a virtual character 306 (the third character formation position 305) for a target character formation position, that is, when the virtual character 306 is located in the third character formation position 305, the virtual character 306 is controlled to present a target formation position character state corresponding to the target character formation position. In the figure, the target formation position character state is that an orientation of the virtual character is at an angle of 45 degrees to a center line of a formation.

In conclusion, in this aspect described herein, the terminal may display the formation template selected by the user in the virtual environment, the formation template including at least two character formation positions, and display, when the virtual character is located in the target character formation position in the formation template, the virtual character in the target formation position character state corresponding to the target character formation position. Therefore, a formation position character state corresponding to a character formation position in the formation template may be set, so that the virtual character located in the character formation position in the formation template can present the formation position character state corresponding to the character formation position in the virtual environment when the formation template is used. In other words, the virtual character is controlled to be in a particular character formation position in the formation template, to quickly display the virtual character in the corresponding character state, so that efficiency of controlling the virtual character is improved. In addition, the character state of the virtual character does not need to be manually controlled to be adjusted, which simplifies related user operations. In addition, because the formation template usually includes at least two character formation positions, at least two virtual characters may be simultaneously controlled to present corresponding character states rather than controlling a single virtual character to present a particular character state. In addition, since the character state presented by the virtual character is consistent with the formation position character state in the formation template, the at least two virtual characters can present interactive states based on the formation template during display of the virtual character, thus enriching virtual character display forms and diversifying virtual character display manners.

In this aspect described herein, after the virtual character is located in the target character formation position, the terminal controls the virtual character to present the target formation position character state corresponding to the target character formation position. Therefore, after the virtual character is located in the target character formation position, the terminal first obtains a target state parameter corresponding to the target character formation position based on a template identifier of the target formation template and a formation position identifier of the target character formation position.

In this aspect described herein, one formation template corresponds to a quantity of formation positions and a state parameter corresponding to each formation position in a formation. The data may be stored in a terminal or in a server configured to perform backend support for an application providing a virtual environment. In addition, in a storage space, different formation templates have different template identifiers. The template identifiers are parameters configured for distinguishing between different formation templates, which are unique.

One formation template includes at least two character formation positions. Different character formation positions have different formation position identifiers, different character formation positions may correspond to different formation position character states, and the formation position character states are determined based on state parameters. Therefore, before controlling the virtual character to present the formation position character state corresponding to the target character formation position, the terminal needs to determine the currently applied formation template based on the template identifier of the target formation template, and then obtain the corresponding target state parameter based on the formation position identifier of the target character formation position in which the virtual character is located.

After the target state parameter is obtained, the virtual character is controlled to present the target formation position character state indicated by the target state parameter.

The target state parameter includes at least one of a target posture parameter, a target orientation parameter, and a target action parameter corresponding to the virtual character located in the target character formation position.

The target posture parameter is configured for defining a posture of the virtual character in a static frame. After obtaining the target state parameter, the terminal controls, based on the target posture parameter in the target state parameter, the virtual character to present the target posture indicated by the target posture parameter.

The target orientation parameter is configured for determining an orientation of the virtual character in the target character formation position. The orientation of the virtual character in the target character formation position needs to be consistent with an orientation of the target character formation position. The orientation may be specifically a relative orientation between a front of the target character formation position and the front of the target formation template. For example, the front of the target character formation position is offset by 90 degrees in a clockwise direction from the front of the target formation template. In this case, when the front of the target formation template in the virtual environment is a due east direction, the orientation of the target character formation position in the virtual environment is a due north direction. In some aspects, an orientation indicated by the target orientation parameter is a relative orientation of the target character formation position in the target formation template. When the target state parameter is obtained, the terminal adjusts, based on the target orientation parameter in the target state parameter, a character orientation of the virtual character to the target orientation indicated by the target orientation parameter, the character orientation of the virtual character being consistent with a formation position orientation of the target character formation position.

The target action parameter is configured for defining a dynamic action to be performed by the virtual character in the target character formation position. After obtaining the target state parameter, the terminal controls, based on the target action parameter in the target state parameter, the virtual character to perform the target action indicated by the target action parameter.

In a possible implementation, the target state parameter may further indicate a starting time at which the virtual character located in the target character formation position performs the target action. In some aspects, the target state parameter may instruct to trigger all of the virtual characters in the target formation template to simultaneously start to perform the target actions corresponding to the character formation positions in which the virtual characters are located after all of the character formation positions in the target formation template are occupied by the virtual characters, to control the virtual characters located in the character formation positions to simultaneously start to perform the corresponding target actions. In some aspects, the target state parameter may instruct to trigger all of the virtual characters in the target formation template to sequentially perform, in a particular sequence, the target actions corresponding to the character formation positions in which the virtual characters are located after all of the character formation positions in the target formation template are occupied by the virtual characters. In addition, a particular logical relationship may exist between the target actions indicated by the target state parameter. The virtual characters in the character formation positions are controlled based on the logical relationship to sequentially perform the corresponding target actions, to form an effect of interaction between the virtual characters. For example, the interaction effect may be that a first virtual character waves a hand to a second virtual character and then the second virtual character greets the first virtual character.

In another possible implementation, after the virtual characters are controlled to start to perform the target actions, video recording may be performed on the virtual characters in the target formation template by using a camera model, so as to record a video of interaction between the virtual characters. In addition, during the video recording by the camera, the character formation position in the virtual environment may be in a hidden state, to obtain a better video effect.

In this way, the target state parameter corresponding to the target character formation position is accurately obtained based on the template identifier of the target formation template selected for application and the formation position identifier of the target character formation position. Further, the virtual character in the target character formation position is controlled to present the corresponding character state based on at least one of the target posture parameter, the target orientation parameter, and the target action parameter in the target state parameter, to implement fine and accurate control on the virtual character, so that the virtual character accurately presents the required character state. In addition, because the at least two virtual characters may be simultaneously controlled to present the corresponding character states by using the target formation template, the at least two virtual characters can be more flexibly controlled to present corresponding character states as actually needed, to display an effect of interaction between the virtual characters.

In this aspect described herein, a plurality of formation templates may be simultaneously applied in the same virtual environment, and display effects of the plurality of formation templates may be different. A process of displaying a character formation position in a virtual environment is described below by using an illustrative aspect.

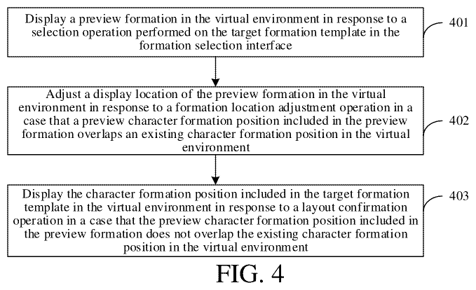

FIG. 4 is a flowchart of a process of displaying a character formation position in a virtual environment according to an illustrative aspect described herein. The process includes the following operations:

Operation 401: Display a preview formation in the virtual environment in response to a selection operation performed on the target formation template in the formation selection interface.

The preview formation is configured for the user to view an application effect of the target formation template in the virtual environment before the target formation template is applied to the virtual environment.

When the preview formation is displayed, the terminal may adjust a location and an orientation of the preview formation in the virtual environment in response to a control operation performed by the user on the preview formation.

Operation 402: Adjust a display location of the preview formation in the virtual environment in response to a formation location adjustment operation in a case that a preview character formation position included in the preview formation overlaps an existing character formation position in the virtual environment.

In this aspect described herein, a plurality of formation templates may be simultaneously applied in the virtual environment, that is, a plurality of character formation positions may be simultaneously displayed in the virtual environment. The plurality of formation templates may be a plurality of formation templates controlled for application by the same terminal, or may include formation templates controlled for application by corresponding terminals in which accounts of teammates in the same virtual environment are logged. In some aspects, in the same virtual environment, a formation template controlled for application by a terminal in which an account of a non-teammate is logged might not be displayed, to avoid impact of a character formation position displayed in the virtual environment on other users.

In some aspects, the formation location adjustment operation may be a dragging operation performed by the user on a character formation position included in the preview formation, and a relative location of the character formation position in the formation template is not changed during the dragging. The dragging operation can control the orientation and the location of the formation template.

In some aspects, the preview formation and a wheel control are displayed in the virtual environment in response to an application operation performed on the virtual environment, the wheel control being configured to trigger adjustment of the display location of the preview formation in the virtual environment. In addition, a joystick control is displayed below the wheel control, and the joystick control is configured for adjusting the orientation of the preview formation. Specifically, in response to a pushing operation performed on the wheel control, the preview formation is controlled to translate in a direction indicated by the push operation; and in response to a sliding operation performed on the joystick control, the preview formation is controlled to rotate in a direction indicated by the sliding operation.

The foregoing two manners are used as examples to describe the process of adjusting the display location of the preview formation in the virtual environment. During an actual application, a person skilled in the art may set the formation location adjustment operation for the preview formation based on a specific application scenario, which is not limited in this aspect.

In some aspects, in a case that the preview character formation position included in the preview formation overlaps the existing character formation position in the virtual environment, the terminal may display prompt information, to prompt the user that the existing character formation position overlaps a character formation position in a preset formation position, and to prompt the user to trigger the formation location adjustment operation.

In this aspect described herein, in a case that there is no existing character formation position in the virtual environment, after the preview formation is displayed in the virtual environment in response to the selection operation performed on the target formation template in the formation selection interface, the user may further perform the formation location adjustment operation to control the display location of the preview formation in the virtual environment. Moreover, a layout confirmation control is displayed while the preview formation is displayed. In response to a touch operation performed by the user on the layout confirmation control, the target character formation position in the target formation template is displayed at the display location of the preview character formation position in the preview formation in the virtual environment.

Operation 403: Display the character formation position included in the target formation template in the virtual environment in response to a layout confirmation operation in a case that the preview character formation position included in the preview formation does not overlap the existing character formation position in the virtual environment.

A display effect of the character formation position in the target formation template is different from a display effect of the existing character formation position. In addition, a display effect of the preview character formation position included in the preview formation is different from the display effects of both the existing character formation position and the character formation position in the target formation template. The difference between the display effects may lie in a color, a line, a shape, an animation effect, and the like, which is not limited in this aspect.

The layout confirmation operation may be a touch operation performed on the layout confirmation control, or may be a touch and hold operation, a double-clicking/tapping operation, or the like performed on the preview formation. A specific form of the layout confirmation operation is not limited in this aspect.

The terminal displays the character formation position included in the target formation template at the character formation position included in the preview formation in the virtual environment in response to the layout confirmation operation. In other words, the display location of the character formation position in the target formation template is the same as the display location of the character formation position in the preview formation in the virtual environment. In addition, an overall orientation of the target formation template displayed in the virtual environment is also the same as an overall orientation of the preview formation.

In this aspect described herein, a corresponding terminal in which an account of a teammate is logged displays, in the virtual environment, a character formation position in a formation template arranged by a corresponding terminal in which another account in a team is logged. Therefore, a terminal applying a formation template to which the existing character formation position in the virtual environment belongs may be a terminal in which a current account is logged, or may be a corresponding terminal in which an account of a teammate is logged.

In some aspects, a first quantity upper limit is set for a quantity of formation templates applied by accounts in the same group in the virtual environment. In a case that a quantity of the formation templates applied in the virtual environment by a team to which the user belongs does not reach the first quantity upper limit, the terminal displays the character formation position included in the target formation template in the virtual environment in response to the layout confirmation operation. In a case that the quantity of formation templates applied in the virtual environment by the team to which the user belongs reaches the first quantity upper limit, the terminal displays prompt information in response to the layout confirmation operation. The prompt information is configured for prompting that the quantity of formation templates currently applied by the team reaches the upper limit and formation layout fails.

In some other aspects, a second quantity upper limit is set for a quantity of formation templates that may be controlled by different accounts to be applied in the virtual environment. In a case that a quantity of formation templates applied in the current virtual environment by the user does not reach the second quantity upper limit, the terminal displays the character formation position included in the target formation template in the virtual environment in response to the layout confirmation operation. In a case that the quantity of formation templates applied in the current virtual environment by the user reaches the second quantity upper limit, the terminal displays prompt information in response to the layout confirmation operation. The prompt information is configured for prompting that the quantity of formation templates currently applied by the user reaches the upper limit and formation layout fails.

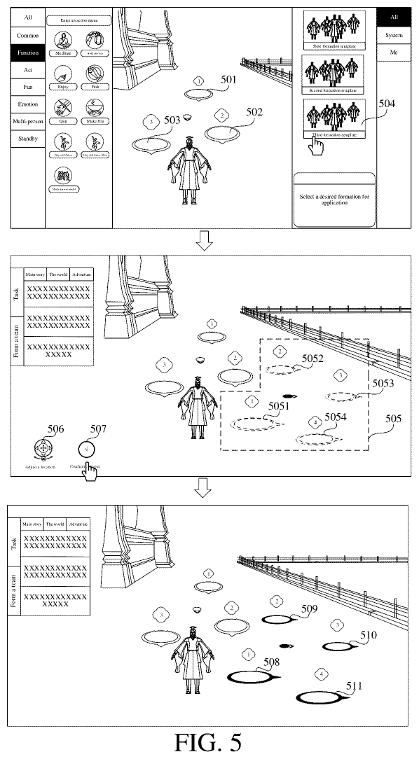

FIG. 5 is a schematic diagram of an application process of a target formation template according to an illustrative aspect described herein. A first character formation position 501, a second character formation position 502, and a third character formation position 503 included in the first formation template are already displayed in the virtual environment. In response to an application operation (corresponding to a tapping operation in the figure) performed on the third formation template 504, a preview formation 505 is displayed in the virtual environment, including a first preview character formation position 5051, a second preview character formation position 5052, a third preview character formation position 5053, and a fourth preview character formation position 5054, and display effects of the preview character formation positions in the preview formation 505 in the figure are different from display effects of existing character formation positions (corresponding to different lines in the figure). Moreover, a location adjustment control 506 is displayed while the preview formation 505 is displayed, and is configured to support the user to adjust a display location of the preview formation. A layout confirmation control 507 is displayed in a case that the preview character formation positions included in the preview formation do not overlap the existing character formation position in the virtual environment.

A fourth character formation position 508, a fifth character formation position 509, a sixth character formation position 510, and a seventh character formation position 511 included in the target formation template are displayed in the virtual environment in response to the layout confirmation operation (corresponding to a tapping/clicking operation performed on the layout confirmation control 507 in the figure). In addition, the fourth character formation position 508, the fifth character formation position 509, the sixth character formation position 510, and the seventh character formation position 511 respectively correspond to the first preview character formation position 5051, the second preview character formation position 5052, the third preview character formation position 5053, and the fourth preview character formation position 5054. Display effects of the character formation positions in the target formation template are different from the display effects of the existing character formation positions (corresponding to different formation position filling conditions in the figure).

In this aspect described herein, in response to the application operation performed on the target formation template, the terminal may first display the preview formation in the virtual environment, so as to determine whether to adjust the application location of the target formation template in the virtual environment by viewing the preview formation. For example, the terminal determines whether to adjust the application location of the target formation template by viewing whether the preview character formation positions in the preview formation overlap the existing character formation positions, to achieve a better application effect, and prevent the character formation positions from shielding each other. In addition, the display effects of the currently applied character formation positions are different from the display effects of the existing character formation positions, which helps the user to distinguish between character formation positions in different formations.

In this aspect described herein, the formation template may be a system formation template configured by default in an application providing the virtual environment, or may be a formation template designed by the user. In this aspect described herein, the application includes a formation editor, which supports formation template designing by the user. In the formation editor, the user may edit different character formation positions, so as to edit relative locations and orientations of the character formation positions in the formation template, formation position character states corresponding to the character formation positions, and the like.

First, the terminal displays a formation position editing interface, the formation position editing interface being configured for editing a formation corresponding to the target formation template and formation position character states corresponding to the character formation positions included therein. The formation includes relative locations of all of the formation positions.

In a case that the formation editor needs to be enabled, the formation position editing interface is displayed in response to a trigger operation performed on the formation editor.

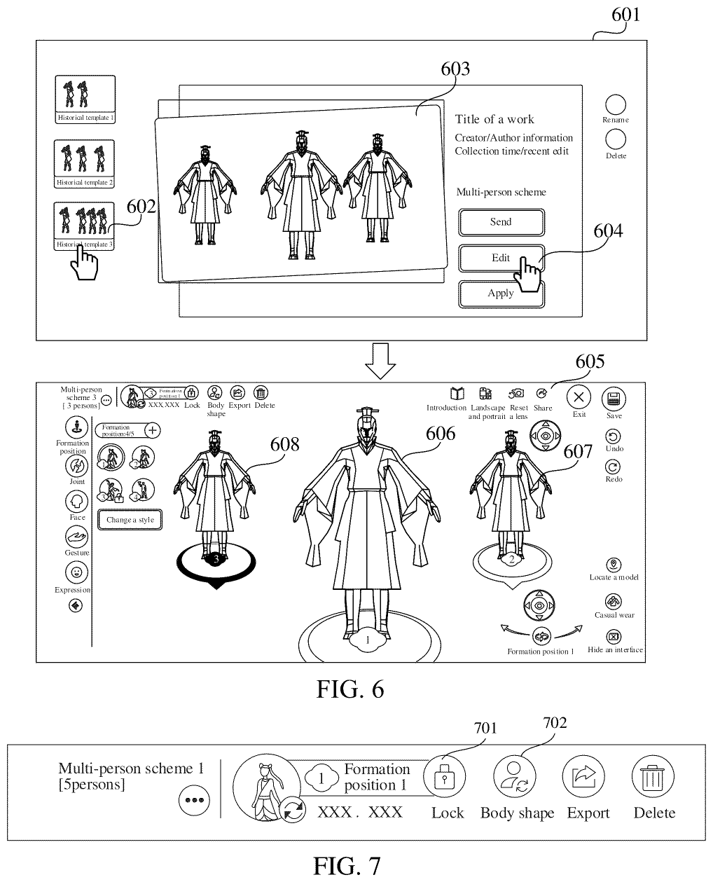

Exemplarily, FIG. 6 is a schematic diagram of displaying a formation position editing interface according to an illustrative aspect described herein. In the figure, a first historical formation template, a second historical formation template, and a third historical formation template 602 are displayed on a first display interface 601. In addition, a preview view 603 of the third historical formation template is displayed in response to a tapping/clicking operation performed on the third historical formation template 602. A formation position editing interface 605 is displayed in response to a tapping/clicking operation performed on an editing control 604. The formation position editing interface 605 includes three character formation positions, formation position identifiers of the three character formation positions are respectively 1, 2, and 3, and the three character formation positions respectively carry a first example virtual character 606, a second example virtual character 607, and a third example virtual character 608. Character states of the example virtual characters correspond to state parameters of the character formation positions to which the virtual characters belong.

In some aspects, an initial formation selection interface is displayed in response to a trigger operation performed on the formation editor. The initial formation selection interface includes at least two initial formations. The initial formation may be a formation historically edited by a user, or may be a formation set by default in a system. The formation position editing interface is displayed in response to a selection operation performed on an initial target formation, and a candidate character formation position included in the initial target formation and an example virtual character located in the candidate character formation position are displayed in the formation position editing interface.

In the formation position editing interface, the user may edit the candidate character formation position as follows by using the terminal.
1. The terminal highlights, in response to a selection operation performed on a candidate character formation position in the target formation template (i.e., the foregoing initial target formation), a formation position identifier of the candidate character formation position in the formation position editing interface.

The selection operation may be a tapping/clicking operation performed on the candidate character formation position, a tapping/clicking operation performed on the formation position identifier of the candidate character formation position, a touch and hold operation performed on the candidate character formation position, a sliding operation, or the like, which is not limited in this aspect.

Exemplarily, as shown in FIG. 6, in the formation position editing interface, a formation position identifier corresponding to a formation position in which the third example virtual character 608 is located is highlighted (corresponding to a part filled with black in the figure) in response to a selection operation performed on the formation position in which the third example virtual character is located in the initial target formation template.

In a possible implementation, in response to performed on a selection operation on the candidate character formation position, a formation observation perspective is adjusted based on a location of the candidate character formation position in the formation. After the formation observation perspective is adjusted, the example virtual character in the candidate character formation position is not shielded by an example virtual character in another character formation position, and a display proportion of the example virtual character in the candidate character formation position is larger.

When a distance between two character formation positions in a formation is relatively small, and the formation observation perspective is inappropriate, the example virtual characters may shield each other. Therefore, to avoid impact of another example virtual character on character state editing of a shielded example virtual character, after selecting the candidate character formation position, the terminal may adjust the formation observation perspective based on a location of the selected example virtual character (i.e., a location of the candidate character formation position in the formation).

In addition, the display proportion of the example virtual character in the selected candidate character formation position is adjusted, so that the display proportion of the example virtual character is greater than a display proportion before the adjustment, thereby helping the user observe a change of a character state of the example virtual character in the candidate character formation position. Changing the display proportion does not substantially affect the character state corresponding to the candidate character formation position, and the adjustment of the display proportion takes effect only when the candidate character formation position is selected.

In some aspects, the user may manually change the formation observation perspective, to satisfy observation demands of the user at different perspectives.

In another possible implementation, the candidate character formation position may be locked. When the candidate character formation position is locked, the character state corresponding to the candidate character formation position cannot be adjusted, so that a character state of the candidate character formation position can be prevented from being changed as a result of accidental touch generated during editing of another character formation position.

Exemplarily, as shown in FIG. 7, the formation position editing interface further includes a locking control 701, a body shape switching control 702, an export control, a deletion control, and the like. A current candidate character formation position (a formation position 1) is locked in response to a trigger operation performed on the locking control 701. The locked formation position 1 is kept in a current character state, and the terminal cannot control the character state corresponding to the formation position 1 to change. The current candidate character formation position (the formation position 1) is unlocked in response to another trigger operation performed on the locking control 701, and the unlocked formation position 1 may be normally edited.
2. An edited character posture is displayed through an example virtual character in the candidate character formation position in response to a posture editing operation performed on the candidate character formation position.

In a possible implementation, in response to a selection operation performed on a target style in a style list in the formation position editing interface, the terminal displays, through an example virtual character in the candidate character formation position, a character font corresponding to the selected target style. The style list may include system preset styles and styles historically edited by the user.

In another possible implementation, the terminal displays an edited character posture through the example virtual character in the candidate character formation position in response to a rotation operation performed on a skeletal point of the example virtual character in the candidate character formation position. The rotation operation may be a two-dimensional rotation operation or a three-dimensional rotation operation.

In this aspect, the posture editing process is described merely by using the foregoing two possible implementations, which do not constitute a limitation on the application scope of this aspect.

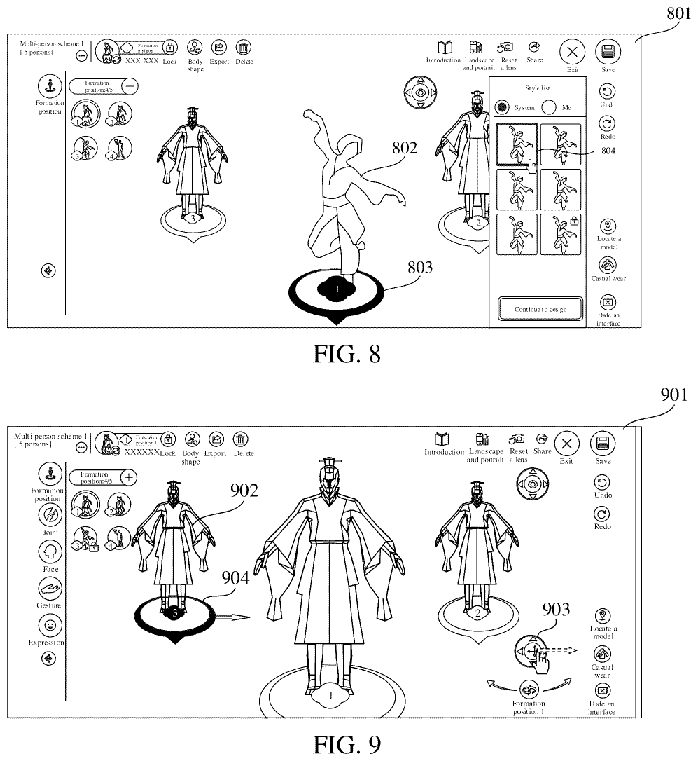

Exemplarily, as shown in FIG. 8, a first example virtual character 802, a second example virtual character, and a third example virtual character are displayed in a formation position editing interface 801, and a first candidate character formation position 803 to which the first example virtual character 802 belongs is selected. In addition, a style list is displayed in the formation position editing interface 801, and a first style control 804 is selected. Therefore, the first example virtual character is displayed in the first style corresponding to the first style control 804.
3. An edited character action is displayed through the example virtual character in the candidate character formation position in response to an action editing operation performed on the candidate character formation position.

In some aspects, a user may adjust a character action of the example virtual character through formation editing, and the character action may be a dynamic action.

In some aspects, the system has a preset dynamic action stored therein. The user may select a target action from the action list, to implement the action editing operation on a candidate character formation position, so that the example virtual character in the candidate character formation position presents the target action. In some aspects, the user may edit a plurality of static posture frames for the candidate character formation position through static frame posture setting, and sequentially combine the plurality of posture frames and configures the posture frames to be played in order, to complete the action editing operation on the candidate character formation position. For a manner of performing posture editing on the posture frames, reference may be made to the process of performing the posture editing operation in the foregoing aspect. Details are not described herein in this aspect.
4. A location of the candidate character formation position in the formation corresponding to the target formation template is adjusted in response to a location adjustment operation performed on the candidate character formation position.

In a possible implementation, the location adjustment operation may be a dragging operation performed on the candidate character formation position. The candidate character formation position is controlled to move in a dragging direction in response to the dragging operation performed on the candidate character formation position.

In another possible implementation, a wheel control is displayed in the formation position editing interface, and the candidate character formation position is controlled to move in a wheel pushing direction in response to a pushing operation performed on the wheel control. Exemplarily, as shown in FIG. 9, three candidate character formation positions are displayed in a formation position editing interface 901, and a third candidate character formation position 904 with a formation position identifier of 3 is selected. After the candidate character formation position is selected, a wheel control 903 is displayed in the formation position editing interface 901. The wheel control 903 is configured for controlling a location of the candidate character formation position in a formation. The third candidate character formation position 904 is adjusted to move rightward in response to a rightward pushing operation performed on the wheel control 903. Correspondingly, an example virtual character 902 in the third candidate character formation position 904 synchronously moves rightward with the third candidate character formation position 904.
5. A character orientation of the example virtual character in the candidate character formation position is adjusted in response to an orientation adjustment operation performed on the candidate character formation position.

In a possible implementation, a joystick control is displayed in the formation position editing interface, and the candidate character formation position is controlled to rotate in a joystick pushing direction in response to a pushing operation performed on the joystick control, to adjust the character orientation of the example virtual character in the candidate character formation position.

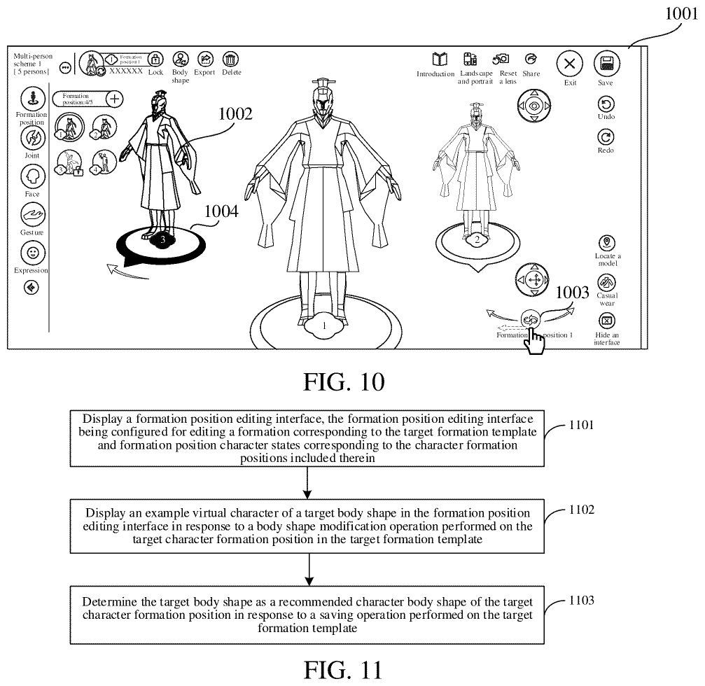

Exemplarily, as shown in FIG. 10, three candidate character formation positions are displayed in a formation position editing interface 1001, and a third candidate character formation position 1004 with a formation position identifier of 3 is selected. After the candidate character formation position is selected, a joystick control 1003 is displayed in the formation position editing interface. The joystick control 1003 is configured for controlling a character orientation of the virtual character in the candidate character formation position. An example virtual character 1002 in the third candidate character formation position 1004 is adjusted to rotate leftward in response to an operation of pushing the joystick control 1003 leftward, to adjust an orientation of the example virtual character 1002.
6. A quantity of the character formation positions included in the target formation template in the formation position editing interface is adjusted in response to a formation position quantity editing operation performed on the target formation template.

In the formation position editing interface, the user may increase a quantity of character formation positions in the target formation template or reduce the quantity of character formation positions in the target formation template based on a design requirement.

In some aspects, a candidate formation list is displayed in the formation position editing interface. The candidate formation list includes a plurality of candidate formations. Quantities of formation positions and formation position arrangements in the candidate formations may be different. For example, the candidate formation list may include a 3-person formation, a 5-person formation, a 7-person formation, a 10-person formation, and the like.

In some aspects, a quantity upper limit is set for a quantity of formation positions included in a formation template. In a case that a quantity of formation positions in the current target formation template reaches the quantity upper limit, a quantity prompt message is displayed in response to an operation of increasing the quantity of formation positions performed on the target formation template, to prompt the user that the quantity of character formation positions in the current target formation template reaches the upper limit. In a case that the quantity of formation positions in the current target formation template does not reach the quantity upper limit, the quantity of the character formation positions in the formation position editing interface is increased in response to the operation of increasing the quantity of formation positions performed on the target formation template.

In this aspect described herein, displaying the example virtual character in the formation position editing interface is merely an example of displaying a current formation position editing state, and the example virtual character is not displayed in an application process.

In this aspect described herein, the user may edit the formation template by using the formation position editing interface. Specifically, a formation, a quantity of character formation positions, and an orientation, a posture, an action, and the like of a virtual character in a character formation position may be edited, to construct a formation template meeting needs of the user. In addition, more diversified virtual character display manners may be provided by using the formation template constructed by the user.

In this aspect described herein, because different virtual characters may have different body shapes, a body shape of the example virtual character in the formation position editing interface may be different from a body shape of the virtual character located in the character formation position when the formation position template is applied. For example, when the user creates an action of stroking hair of the second virtual character by the first virtual character, the user needs to edit actions or postures in different character formation positions in the formation position editing interface. During the editing, the body shape of the example virtual character displayed in the formation position editing interface may be different from the body shape of the virtual character located in the character formation position when the user applies the formation position template.

Therefore, to view states of virtual characters having different body shapes in character formation positions during editing of character postures or character actions in the formation position editing interface, FIG. 11 is a flowchart of a manner of switching a virtual character body shape according to an illustrative aspect described herein. The manner includes the following operations:

Operation 1101: Display a formation position editing interface, the formation position editing interface being configured for editing a formation corresponding to the target formation template and formation position character states corresponding to the character formation positions included therein.

For a specific implementation of this operation, reference may be made to the implementation of displaying the formation position editing interface in the foregoing aspect. Details are not described in this aspect.

Operation 1102: Display an example virtual character of a target body shape in the formation position editing interface in response to a body shape modification operation performed on the target character formation position in the target formation template.

In a possible implementation, after the target character formation position is selected in the formation position editing interface, the example virtual character of the target body shape is displayed in the target character formation position in the formation position editing interface in response to the body shape modification operation performed on the target character formation position, the target body shape being a body shape of the example virtual character.

In some aspects, a body shape modification control, for example, a body shape modification control 702 in FIG. 7, is displayed in the formation position editing interface. A candidate body shape list is displayed in response to a trigger operation performed on the body shape modification control. The candidate body shape list includes at least two candidate body shapes. The example virtual character of the target body shape is displayed in the formation position editing interface in response to a trigger operation performed on the target body shape.

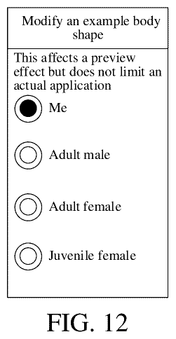

Exemplarily, FIG. 12 is a schematic diagram of a candidate body shape list according to an illustrative aspect described herein. The candidate body shape list includes four candidate body shapes, including Me, Adult male, Adult female, and Juvenile female. “Me” refers to a body shape of a virtual character currently controlled by an account logged in the terminal, and includes a body shape, an appearance, clothes, and the like of the virtual character controlled by the account. In addition, Adult male, Adult female, and Juvenile female correspond to different body shapes. In addition, prompt information with content “This affects a preview effect but does not limit an actual application” is displayed in the body shape candidate list, which is configured for prompting the user that the body shape modification operation is performed in the formation position editing interface to present character state effects of virtual characters of different body shapes in the formation position editing interface, which are not equivalent to an actual application effect.

Operation 1103: Determine the target body shape as the recommended character body shape of the target character formation position in response to a saving operation performed on the target formation template.

After the body shape of the example virtual character is modified, the body shape of the example virtual character currently presented in the target character formation position is determined as the recommended character body shape of the target character formation position in response to the saving operation performed on the target formation template. The recommended character body shape brings an optimal display effect when a virtual character of the recommended character body shape is carried in the character formation position.

In some aspects, a character state parameter of the character formation position is adjusted in the formation position editing interface in response to an editing operation performed on the character formation position. The character state parameter corresponding to the target character formation position is stored in the target formation template in response to the saving operation performed on the target formation template.

In this aspect described herein, the body shape of the example virtual character in the character formation position may be switched in the formation position editing interface, so that the user views character states of the character formation position presented by virtual characters of different body shapes, which is more beneficial to the user to edit the character formation position based on the display effects, thereby achieving a better virtual character display effect. In addition, corresponding recommended character body shapes are set for different character formation positions based on a character formation position editing result, so that virtual characters matching the recommended character body shapes can be located in corresponding character formation positions when the formation template is applied, thereby helping improve the display effect of the virtual characters.

After the target formation template is applied, different character formation positions may be selected for different virtual characters. In a possible implementation, assistance may be provided for the user to select a corresponding target character formation position for a virtual character based on a distance between the virtual character and the target character formation position.

A state display control is displayed in a case that the distance between the virtual character and the target character formation position is less than a first distance threshold. The state display control is configured to trigger control of the virtual character to present the target formation position character state corresponding to the target character formation position. The virtual character is controlled to move to the target character formation position in response to a trigger operation performed on the state display control.

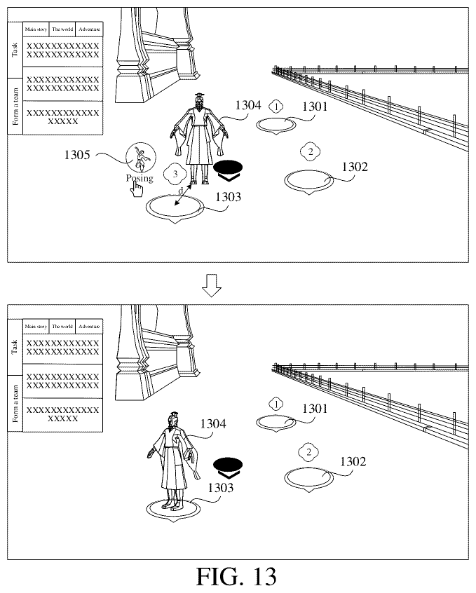

Exemplarily, FIG. 13 is a schematic diagram of controlling a virtual character to be in a target character formation position according to an illustrative aspect described herein. The target formation template displayed in the virtual environment includes a first character formation position 1301, a second character formation position 1302, and a third character formation position 1303. In addition, the virtual environment further includes a virtual character 1304. In the figure, a distance d between the virtual character 1304 and the third character formation position 1303 is less than a first distance threshold. In this case, a state display control 1305 (corresponding to a posing control in the figure) is displayed. Subsequently, in response to a tapping/clicking operation performed on the state display control 1305, the virtual character is controlled to move to the third character formation position 1303, and the virtual character is controlled to present a character state of the third character formation position (corresponding to rotating leftward by 45 degrees in the figure) in the third character formation position 1303.

In this aspect, a manner of controlling the virtual character to move to the target character formation position is described only in one manner. In addition, another manner such as triggering a tapping/clicking operation on the target character formation position may also be used, which constitutes no limitation to the application scope of this aspect described herein.

In another possible implementation, after the virtual character is located in the target character formation position, a state separation control is displayed, and the virtual character is controlled to separate from the target character formation position in response to a trigger operation performed on the state separation control, to cancel the character state corresponding to the target character formation position presented by the virtual character.

In this way, in a case that the distance between the virtual character and the target character formation position is relatively small, the virtual character is controlled to rapidly move to the target character formation position, and to present the formation position character state corresponding to the target character formation position, thereby implementing efficient control on the virtual character.

In some aspects, the terminal determines the target body shape as the recommended character body shape of the target character formation position in response to the saving operation performed on the formation template. Therefore, to achieve a better virtual character display effect, when the user selects a virtual character for the target character formation position, the terminal performs matching between a body shape of the virtual character and the recommended character body shape, so that the user can select a more suitable virtual character for the target character formation position.

In a possible implementation, when detecting that the distance between the virtual character and the target character formation position is less than the first distance threshold, the terminal obtains a recommended character body shape corresponding to the target character formation position and a character body shape of the virtual character, and determines whether the recommended character body shape matches the character body shape.

In some aspects, the state display control is displayed in a case that the distance between the virtual character and the target character formation position is less than the first distance threshold and the character body shape of the virtual character matches the recommended character body shape corresponding to the target character formation position.

In some aspects, the state display control and prompt information are displayed in a case that the distance between the virtual character and the target character formation position is less than the first distance threshold and the character body shape of the virtual character does not match the recommended character body shape corresponding to the target character formation position, the prompt information being configured for prompting that the character body shape of the virtual character does not match the recommended character body shape corresponding to the target character formation position.

In this aspect described herein, regardless of whether the character body shape of the virtual character matches the recommended character body shape of the target character formation position, the user may move the virtual character to the target virtual character through a trigger operation performed on the state display control, and display the character state corresponding to the target character formation position. Displaying the prompt message helps guide the user select a more suitable character formation position for the virtual character, so as to improve the display effect of the virtual character.

After the character formation position in the target formation template is displayed in the virtual environment in response to the application operation, if the user applying the target formation template no longer needs to use the target formation template, application of the target formation template needs to be canceled.

In a possible implementation, a formation core corresponding to the target formation template is further displayed in the virtual environment. A formation withdrawing control is displayed in a case that a distance between the virtual character and the formation core is less than a second distance threshold. The terminal stops displaying the character formation positions included in the target formation template in the virtual environment in response to a trigger operation performed on the formation withdrawing control.

The formation core corresponding to the target formation template may be configured for indicating an overall location and a formation orientation of the target formation template in the virtual environment. If the virtual character approaches formation core, the target formation template may no longer need to be displayed, and therefore the terminal displays the formation withdrawing control. The formation withdrawing control is configured to guide the user to withdraw the formation.

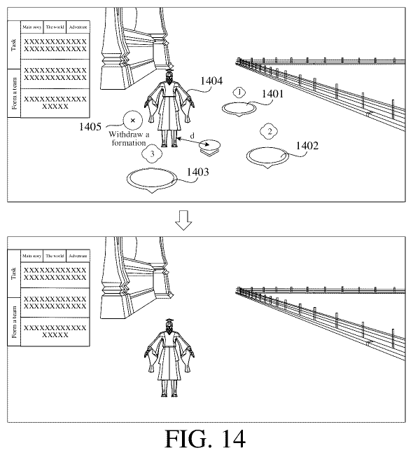

Exemplarily, FIG. 14 is a schematic diagram of a process of withdrawing a formation template according to an illustrative aspect described herein. A first character formation position 1401, a second character formation position 1402, and a third character formation position 1403 included in the target formation template are displayed in the virtual environment. In addition, the virtual environment further includes a virtual character 1404. In the figure, a distance d between the virtual character 1404 and a formation core is less than the second distance threshold. In this case, the formation withdrawing control 1405 is displayed. Subsequently, displaying of the character formation positions included in the target formation template in the virtual environment is stopped in response to a tapping/clicking operation performed on the formation withdrawing control 1405.

In a possible implementation, after the target formation template is withdrawn, the virtual character originally displayed in the character formation position still remains in the character state displayed in the character formation position. Alternatively, after the formation template is withdrawn, the virtual character originally displayed in the character formation position stops remaining in the character state corresponding to the character formation position.

In a possible implementation, a duration threshold for displaying the character formation position is set. In a case that a duration for which the character formation position in the target formation template is displayed in the virtual environment reaches the duration threshold, the displaying of the character formation position in the target formation template is automatically canceled.

In some aspects, a character formation position in the target formation template controlled by the terminal for placement is visible to a virtual character located in the same team as the user, and is invisible to other virtual characters outside the team in the virtual environment. In addition, the other virtual characters outside the team cannot be located in the character formation position in the target formation template arranged by the terminal, and displaying of the character formation position cannot be controlled to be canceled.

In this aspect described herein, the terminal detects whether a virtual character exists around the formation core, to determine whether the user still needs to use the target formation template, so that a need of the user can be determined more accurately, which is more intelligent. In addition, the formation core is configured as a center of the formation template. Therefore, the user can determine an orientation and an overall location of the target formation template by using the formation core displayed in the virtual environment.

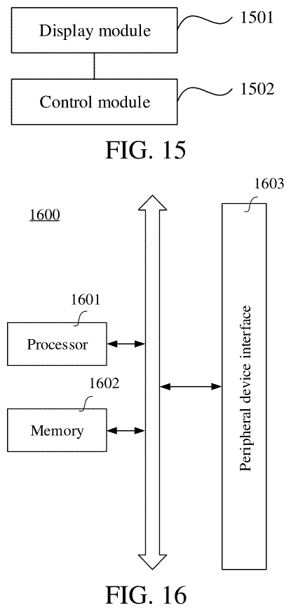

FIG. 15 is a structural block diagram of a virtual character display apparatus according to an illustrative aspect described herein. The apparatus includes:
a display module 1501, configured to display a formation selection interface, the formation selection interface including at least one formation template, the formation template including at least two character formation positions, each of the character formation positions being configured for carrying a virtual character, and each of the character formation positions having a corresponding formation position character state,
the display module 1501 being further configured to display, in response to an application operation performed on a target formation template in the formation selection interface, character formation positions included in the target formation template in a virtual environment; and
a control module 1502, configured to control, in a case that the virtual character is located in a target character formation position in the target formation template, the virtual character to present a target formation position character state corresponding to the target character formation position.

In some aspects, the control module 1502 is configured to:
obtain a target state parameter corresponding to the target character formation position based on a template identifier of the target formation template and a formation position identifier of the target character formation position; and
control the virtual character to present the target formation position character state indicated by the target state parameter.

In some aspects, the control module 1502 is configured to:
control the virtual character to present a target posture based on a target posture parameter in the target state parameter;
control a character orientation of the virtual character to be a target orientation based on a target orientation parameter in the target state parameter; and
control the virtual character to perform a target action based on a target action parameter in the target state parameter.

In some aspects,
the display module 1501 is configured to display a state display control in a case that a distance between the virtual character and the target character formation position is less than a first distance threshold, the state display control being configured to trigger control of the virtual character to present the target formation position character state corresponding to the target character formation position.

The control module 1502 is configured to control the virtual character to move to the target character formation position in response to a trigger operation performed on the state display control.

In some aspects, the display module 1501 is configured to:
display the state display control in a case that the distance between the virtual character and the target character formation position is less than the first distance threshold and a character body shape of the virtual character matches a recommended character body shape corresponding to the target character formation position.

The display module 1501 is further configured to display the state display control and prompt information in a case that the distance between the virtual character and the target character formation position is less than the first distance threshold and the character body shape of the virtual character does not match the recommended character body shape corresponding to the target character formation position, the prompt information being configured for prompting that the character body shape of the virtual character does not match the recommended character body shape corresponding to the target character formation position.

In some aspects, the display module 1501 is further configured to:
display a formation position editing interface, the formation position editing interface being configured for editing a formation corresponding to the target formation template and formation position character states corresponding to the character formation positions included therein; and
display an example virtual character of a target body shape in the formation position editing interface in response to a body shape modification operation performed on the target character formation position in the target formation template.

The apparatus further includes:
a determining module, configured to determine the target body shape as the recommended character body shape of the target character formation position in response to a saving operation performed on the target formation template.

In some aspects, the display module 1501 is configured to:
display a preview formation in the virtual environment in response to a selection operation performed on the target formation template in the formation selection interface; and
display the character formation positions included in the target formation template in the virtual environment in response to a layout confirmation operation in a case that a preview character formation position included in the preview formation overlaps an existing character formation position in the virtual environment, a display effect of the character formation position in the target formation template being different from a display effect of the existing character formation position.

In some aspects, the display module 1501 is configured to:
adjust a display location of the preview formation in the virtual environment in response to a formation location adjustment operation in a case that the preview character formation position included in the preview formation overlaps the existing character formation position in the virtual environment.

In some aspects, a formation core corresponding to the target formation template is further displayed in the virtual environment.

The display module 1501 is further configured to: display a formation withdrawing control in a case that a distance between the virtual character and the formation core is less than a second distance threshold; and stop displaying the character formation positions included in the target formation template in the virtual environment in response to a trigger operation performed on the formation withdrawing control.

In some aspects,
the display module 1501 is further configured to display the formation position editing interface, the formation position editing interface being configured for editing the formation corresponding to the target formation template and the formation position character states corresponding to the character formation positions.

The control module 1502 is further configured to highlight, in response to a selection operation performed on a candidate character formation position in the target formation template, a formation position identifier of the candidate character formation position in the formation position editing interface; display an edited character posture through an example virtual character in the candidate character formation position in response to a posture editing operation performed on the candidate character formation position; display an edited character action through the example virtual character in the candidate character formation position in response to an action editing operation performed on the candidate character formation position; adjust a location of the candidate character formation position in the formation corresponding to the target formation template in response to a location adjustment operation performed on the candidate character formation position; adjust a character orientation of the example virtual character in the candidate character formation position in response to an orientation adjustment operation performed on the candidate character formation position; and adjust a quantity of the character formation positions included in the target formation template in the formation position editing interface in response to a formation position quantity editing operation performed on the target formation template.

In some aspects,
the control module 1502 is configured to adjust a formation observation perspective based on a location of the candidate character formation position in the formation in response to a selection operation performed on the candidate character formation position, after the formation observation perspective is adjusted, the example virtual character in the candidate character formation position being not shielded by an example virtual character in another character formation position, and a display proportion of the example virtual character in the candidate character formation position being larger.

In conclusion, in this aspect described herein, the terminal may display the formation template selected by the user in the virtual environment, the formation template including at least two character formation positions, and display, when the virtual character is located in the target character formation position in the formation template, the virtual character in the target formation position character state corresponding to the target character formation position. Therefore, a formation position character state corresponding to a character formation position in the formation template may be set, so that the virtual character located in the character formation position in the formation template can present the formation position character state corresponding to the character formation position in the virtual environment when the formation template is used. In other words, the virtual character is controlled to be in a particular character formation position in the formation template, to quickly display the virtual character in the corresponding character state, so that efficiency of controlling the virtual character is improved. In addition, the character state of the virtual character does not need to be manually controlled to be adjusted, which simplifies related user operations. In addition, because the formation template usually includes at least two character formation positions, at least two virtual characters may be simultaneously controlled to present corresponding character states rather than controlling a single virtual character to present a particular character state. In addition, since the character state presented by the virtual character is consistent with the formation position character state in the formation template, the at least two virtual characters can present interactive states based on the formation template during display of the virtual character, thus enriching virtual character display forms and diversifying virtual character display manners.

The apparatus provided in the foregoing aspect is illustrated only with an example of division of the foregoing function modules. In practical applications, the foregoing functions may be allocated to and completed by different function modules as required. In other words, the internal structure of the apparatus is divided into different function modules to complete all or some of the functions described above. In addition, the apparatus provided in the foregoing aspect and the method aspect belong to the same concept. For details of an implementation process thereof, reference may be made to the method aspect. The details are not described herein.

FIG. 16 is a structural block diagram of a terminal 1600 according to an illustrative aspect described herein. The terminal 1600 may be a portable mobile terminal, such as a smart phone, a tablet computer, an MP3 player, or an MP4 player. The terminal 1600 may further be referred to as another name such as a user equipment or a portable terminal.

Generally, the terminal 1600 includes a processor 1601 and a memory 1602.

The processor 1601 may include one or more processing cores, such as a 4-core processor or an 8-core processor. The processor 1601 may be implemented in at least one hardware form of a digital signal processor (DSP), a field-programmable gate array (FPGA), and a programmable logic array (PLA). The processor 1601 may further include a main processor and a coprocessor. The main processor is configured to process data in an awake state, and is also referred to as a central processing unit (CPU). The coprocessor is a low-power processor configured to process data in a standby state. In some aspects, the processor 1601 may be integrated with a graphics processing unit (GPU). The GPU is configured to render and draw content that needs to be displayed on a display screen. In some aspects, the processor 1601 may further include an artificial intelligence (AI) processor. The AI processor is configured to process computing operations related to machine learning.

The memory 1602 may include one or more computer-readable storage media. The computer-readable storage media may be tangible and non-transient. The memory 1602 may further include a high-speed random access memory and a non-volatile memory, for example, one or more disk storage devices and flash storage devices. In some aspects, the non-transient computer-readable storage media in the memory 1602 are configured to store at least one instruction. The at least one instruction is configured to be executed by the processor 1601 to implement the virtual character display method provided in the aspects described herein.

In some aspects, the terminal 1600 may further include a peripheral device interface 1603 and at least one peripheral device.

The peripheral device interface 1603 may be configured to connect the at least one peripheral device related to input/output (I/O) to the processor 1601 and the memory 1602. In some aspects, the processor 1601, the memory 1602, and the peripheral device interface 1603 are integrated on the same chip or circuit board. In some other aspects, any one or two of the processor 1601, the memory 1602, and the peripheral device interface 1603 may be implemented on separate chips or circuit boards, which is not limited in this aspect.

A person skilled in the art may understand that the structure shown in FIG. 16 does not constitute a limitation on the terminal 1600, and the computer device may include more or fewer components than those shown in the figure, or some merged components, or different component arrangements.

An aspect described herein further provides a computer-readable storage medium, having at least one program stored therein, the at least one program being loaded and executed by a processor to implement the virtual character display method in the foregoing aspects.

According to an aspect described herein, a computer program product is provided, the computer program product including computer instructions, the computer instructions being stored in a computer-readable storage medium. A processor of a terminal reads the computer instructions from the computer-readable storage medium, and the processor executes the computer instructions, to cause the terminal to perform the virtual character display method provided in the illustrative implementations in the foregoing aspects.

A person skilled in the art is to be aware that in the foregoing one or more examples, the functions described in the aspects described herein may be implemented by hardware, software, firmware, or any combination thereof. When implemented by using software, the functions may be stored in a computer-readable storage medium, or may be transmitted as one or more instructions or codes in the computer-readable storage medium. The computer-readable storage medium includes a computer storage medium and a communication medium. The communication medium includes any medium that facilitates transmission of a computer program from one place to another. The storage medium may be any available medium accessible to a general-purpose or special-purpose computer.

The foregoing descriptions are merely illustrative aspects described herein, and are not intended to limit this application. Any modification, equivalent replacement, or improvement made within the spirit and principle described herein shall fall within the protection scope described herein.

What is claimed is:

1. A computer-implemented method comprising:
displaying a formation selection interface, the formation selection interface comprising at least one formation template, each formation template comprising at least two character formation positions, each of the character formation positions being capable of being associated with a virtual character, and each of the character formation positions having a corresponding formation position character state;
displaying, in response to received user input selecting a target formation template of the at least one formation template, character formation positions of the target formation template in a virtual environment; and
controlling, when the virtual character is located in a target character formation position in the target formation template, the virtual character to present a target formation position character state corresponding to the target character formation position in the target formation template.

2. The method of claim 1, wherein the controlling comprises:
obtaining a target state parameter corresponding to the target character formation position based on a template identifier of the target formation template and a formation position identifier of the target character formation position; and
displaying the virtual character in the target formation position character state indicated by the target state parameter.

3. The method of claim 2, wherein the displaying the virtual character comprises one more of:
controlling the virtual character to present a target posture based on a target posture parameter in the target state parameter;
controlling a character orientation of the virtual character to be a target orientation based on a target orientation parameter in the target state parameter; and
controlling the virtual character to perform a target action based on a target action parameter in the target state parameter.

4. The method of claim 1, wherein before the controlling, the method comprises:
displaying a state display control when a distance between the virtual character and the target character formation position is less than a first distance threshold, the state display control being configured to trigger control of the virtual character to present the target formation position character state corresponding to the target character formation position; and
controlling the virtual character to move to the target character formation position in response to a trigger operation performed on the state display control.

5. The method of claim 4, wherein the displaying a state display control comprises:
displaying the state display control when the distance between the virtual character and the target character formation position is less than the first distance threshold and a character body shape of the virtual character matches a recommended character body shape corresponding to the target character formation position; and
the method further comprises:
displaying the state display control and prompt information when the distance between the virtual character and the target character formation position is less than the first distance threshold and the character body shape of the virtual character does not match the recommended character body shape corresponding to the target character formation position, the prompt information being configured for prompting that the character body shape of the virtual character does not match the recommended character body shape corresponding to the target character formation position.

6. The method of claim 1, further comprising:
displaying a formation position editing interface, the formation position editing interface being configured for editing a formation corresponding to the target formation template and formation position character states corresponding to the character formation positions comprised therein;
displaying an example virtual character of a target body shape in the formation position editing interface in response to a body shape modification operation performed on the target character formation position in the target formation template; and
determining the target body shape as the recommended character body shape of the target character formation position in response to a saving operation performed on the target formation template.

7. The method of claim 1, wherein the displaying character formation positions comprises:
displaying a preview formation in the virtual environment in response to a selection operation performed on the target formation template in the formation selection interface; and
displaying the character formation positions comprised in the target formation template in the virtual environment in response to a layout confirmation operation when a preview character formation position comprised in the preview formation overlaps an existing character formation position in the virtual environment, a display effect of the character formation position in the target formation template being different from a display effect of the existing character formation position.

8. The method of claim 7, wherein the displaying character formation positions comprises:
adjusting a display location of the preview formation in the virtual environment in response to a formation location adjustment operation in a case that the preview character formation position comprised in the preview formation overlaps the existing character formation position in the virtual environment.

9. The method of claim 1, further comprising:
displaying a formation core corresponding to the target formation template in the virtual environment;
displaying a formation withdrawing control in a case that a distance between the virtual character and the formation core is less than a second distance threshold; and
stopping displaying the character formation positions comprised in the target formation template in the virtual environment in response to a trigger operation performed on the formation withdrawing control.

10. The method of claim 6, further comprising:
displaying the formation position editing interface, the formation position editing interface being configured for editing the formation corresponding to the target formation template and the formation position character states corresponding to the character formation positions;
highlighting, in response to a selection operation performed on a candidate character formation position in the target formation template, a formation position identifier of the candidate character formation position in the formation position editing interface;
displaying an edited character posture through an example virtual character in the candidate character formation position in response to a posture editing operation performed on the candidate character formation position;
displaying an edited character action through the example virtual character in the candidate character formation position in response to an action editing operation performed on the candidate character formation position;
adjusting a location of the candidate character formation position in the formation corresponding to the target formation template in response to a location adjustment operation performed on the candidate character formation position;
adjusting a character orientation of the example virtual character in the candidate character formation position in response to an orientation adjustment operation performed on the candidate character formation position; and
adjusting a quantity of the character formation positions comprised in the target formation template in the formation position editing interface in response to a formation position quantity editing operation performed on the target formation template.

11. The method of claim 10, wherein the highlighting comprises:
adjusting a formation observation perspective based on a location of the candidate character formation position in the formation in response to a selection operation performed on the candidate character formation position, after the formation observation perspective is adjusted, the example virtual character in the candidate character formation position being not shielded by an example virtual character in another character formation position, and a display proportion of the example virtual character in the candidate character formation position being larger.

12. One or more non-transitory computer readable media comprising computer readable instructions which, when executed by a processor, configure a data processing system to perform:
displaying a formation selection interface, the formation selection interface comprising at least one formation template, each formation template comprising at least two character formation positions, each of the character formation positions being capable of being associated with a virtual character, and each of the character formation positions having a corresponding formation position character state;
displaying, in response to received user input selecting a target formation template of the at least one formation template, character formation positions of the target formation template in a virtual environment; and
controlling, when the virtual character is located in a target character formation position in the target formation template, the virtual character to present a target formation position character state corresponding to the target character formation position in the target formation template.

13. The computer readable media of claim 13, wherein the displaying the virtual character comprises one more of:
controlling the virtual character to present a target posture based on a target posture parameter in the target state parameter;
controlling a character orientation of the virtual character to be a target orientation based on a target orientation parameter in the target state parameter; and
controlling the virtual character to perform a target action based on a target action parameter in the target state parameter.

14. The computer readable media of claim 12, wherein before the controlling, the computer readable instructions configure the data processing system to perform:
displaying a state display control when a distance between the virtual character and the target character formation position is less than a first distance threshold, the state display control being configured to trigger control of the virtual character to present the target formation position character state corresponding to the target character formation position; and
controlling the virtual character to move to the target character formation position in response to a trigger operation performed on the state display control.

15. The computer readable media of claim 12, wherein the computer readable instructions further configure the data processing system to perform:
displaying a formation position editing interface, the formation position editing interface being configured for editing a formation corresponding to the target formation template and formation position character states corresponding to the character formation positions comprised therein;
displaying an example virtual character of a target body shape in the formation position editing interface in response to a body shape modification operation performed on the target character formation position in the target formation template; and
determining the target body shape as the recommended character body shape of the target character formation position in response to a saving operation performed on the target formation template.

16. The computer readable media of claim 12, wherein the displaying character formation positions comprises:
displaying a preview formation in the virtual environment in response to a selection operation performed on the target formation template in the formation selection interface; and
displaying the character formation positions comprised in the target formation template in the virtual environment in response to a layout confirmation operation when a preview character formation position comprised in the preview formation overlaps an existing character formation position in the virtual environment, a display effect of the character formation position in the target formation template being different from a display effect of the existing character formation position.

17. The computer readable media of claim 16, wherein the displaying character formation positions comprises:
adjusting a display location of the preview formation in the virtual environment in response to a formation location adjustment operation in a case that the preview character formation position comprised in the preview formation overlaps the existing character formation position in the virtual environment.

18. The computer readable media of claim 12, wherein the computer readable instructions further configure the data processing system to perform:
displaying a formation core corresponding to the target formation template in the virtual environment;
displaying a formation withdrawing control in a case that a distance between the virtual character and the formation core is less than a second distance threshold; and
stopping displaying the character formation positions comprised in the target formation template in the virtual environment in response to a trigger operation performed on the formation withdrawing control.

19. The computer readable media of claim 15, wherein the computer readable instructions further configure the data processing system to perform:
displaying the formation position editing interface, the formation position editing interface being configured for editing the formation corresponding to the target formation template and the formation position character states corresponding to the character formation positions;
highlighting, in response to a selection operation performed on a candidate character formation position in the target formation template, a formation position identifier of the candidate character formation position in the formation position editing interface;
displaying an edited character posture through an example virtual character in the candidate character formation position in response to a posture editing operation performed on the candidate character formation position;
displaying an edited character action through the example virtual character in the candidate character formation position in response to an action editing operation performed on the candidate character formation position;
adjusting a location of the candidate character formation position in the formation corresponding to the target formation template in response to a location adjustment operation performed on the candidate character formation position;
adjusting a character orientation of the example virtual character in the candidate character formation position in response to an orientation adjustment operation performed on the candidate character formation position; and
adjusting a quantity of the character formation positions comprised in the target formation template in the formation position editing interface in response to a formation position quantity editing operation performed on the target formation template.

20. A computer-implemented method comprising:
displaying a formation selection interface, the formation selection interface comprising at least one formation template, each formation template comprising at least two character formation positions, each of the character formation positions being capable of being associated with a virtual character, and each of the character formation positions having a corresponding formation position character state;
displaying, in response to received user input selecting a target formation template of the at least one formation template, character formation positions of the target formation template in a virtual environment; and
controlling, when the virtual character is located in a target character formation position in the target formation template, the virtual character to present a target formation position character state corresponding to the target character formation position in the target formation template by depicting the virtual character based on one or more of:
a target posture associated with the target formation position character state;
a target orientation associated with the target formation position character state; and
a target action associated with the target formation position character state.
